(19) United States
(12) Patent Application Publication
(10) Pub. No.: US 2002/0103703 A1
(43) Pub. Date: Aug. 1, 2002

(54) System for providing rewards to a user who reviews an advertiser's web site in response to clicking on a banner advertisement

(75) Inventor: Jeffrey R. Spetalnick, New York, NY (US)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: RADIUS-ALLIANCE, LYNBROOK, NY (US)

(21) Appl. No.: 09/775,028

(22) Filed: Feb. 1, 2001

(51) Int. Cl. G06F 17/60

(52) U.S. Cl. 705/14; 705/1

(57) ABSTRACT

A method for providing rewards to a user who reviews an advertiser's web site in response to clicking a banner advertisement, includes the steps of providing banner advertisements for a first group of a plurality of advertisers on a plurality of websites of a second group; linking the banner advertisements to respective websites of the first group of advertisers; bringing the user to a central website responsible for providing the rewards when the user clicks on a banner advertisement; determining at the central website if the user is a registered user; permitting the user to register at the central website if the user is not a registered user; providing rewards to each registered user for each new banner advertisement clicked on by the user; and then bringing the user to the respective website of the first group of advertisers.

### BACKGROUND OF THE INVENTION

The present invention relates generally to the use of banner advertisements on websites, and more particularly, is directed to a system for rewarding a user with frequent flier miles for viewing an advertiser's web site by clicking on a banner advertisement.

Banner advertisements are a highly popular method of web based advertising. Banner advertisements can be found on most websites, and are often the method by which websites make money or fund their costs. Generally, banner advertisements are placed by advertisers on websites of others so as to reach target markets that would be most interested in the advertiser's products. However, many users, when viewing a website, ignore the banner advertisements at the website. In other words, there is no adequate incentive for the web user to click on the banner advertisement and visit the advertiser's website. In fact, many users, while they may be interested in the advertised product of the banner advertisement, choose not to click on the banner advertisement because it would be an intrusion and distraction from the user's current viewing of the website on which the banner advertisement is displayed, thereby detracting from what the user was aiming to find or accomplish at the website then being visited. In this regard, current banner advertisements often draw attention away from the useful functions of a website, without offering the user any significant gain.

Some websites currently offer benefits to users for viewing certain advertisements or reading specific e-mails containing information about advertisers. These sites offer points that are redeemable for goods and services, but only after a user reads the appropriate information. Thus, in order to amass these points, users are required to visit the sponsoring website or to read e-mails that are sent by the company. For example, there is a website www.coolsavings.com which advertises discounts at other web sites. The website provides a listing of the other websites where the savings can be obtained, the general type of savings and a link to the other websites. When a user clicks on the link, the user is brought to the other website, for example, www.barnesandnoble.com. Each time that the user clicks on a linking website, the user accumulates “cool” points which can be redeemed for prizes. As such, the points are only accessible in certain limited areas. Examples of such known systems are described in U.S. Pat. Nos. 5,774,870 to Storey, 5,806,045 to Biorge et al, and 6,009,412 to Storey. However, there is currently no similar service that offers benefits at multiple locations on the web or that offers its benefits through other advertisers' banner advertisements.

Further, most airlines offer frequent flier miles that may be collected in a variety of ways. The primary method by which miles are collected is by taking plane flights. Miles may also be collected by making purchases on participating credit cards, renting a car from a participating rental car agency, or staying at a participating hotel. However, these latter programs require that the beneficiary of the airline miles make a purchase in order to receive the credits.

Thus, although there are services that offer credits or benefits for reading advertisements and there are methods of earning airline miles, there is no service that is present at a multiplicity of sites that offers the accumulation of airline miles by merely clicking on a banner advertisement at any of a multitude of websites.

### SUMMARY OF THE INVENTION

Accordingly, it is an object of the present invention to provide a system for providing airline reward miles to a user who reviews an advertiser's web site by clicking on a banner advertisement.

It is another object of the present invention to create an improvement on traditional banner advertisements so as to increase the likelihood that Internet users will click on a banner advertisement and thereby be exposed to the advertiser's web site.

It is still another object of the present invention to create a system for Internet users to receive a credit by clicking on a banner advertisement to reach an advertiser's website.

It is yet another object of the present invention to create a database of registered users who are appropriately credited for clicking on banner advertisements.

It is a further object of the present invention to create an innovative way for airlines to market and distribute frequent flier miles.

It is a still further object of the present invention to place a secondary advertiser on the banner advertisements, namely, an airline.

It is still a further object of the present invention to enable a user to view a list of ads that they previously viewed and return to these ads at a later time.

The preceding objects will be achieved by a service that distributes benefits such as frequent flier miles to users who click on specified banner advertisements. The service collects and records user information for registered users. The benefits will be awarded after the user has clicked on a participating advertiser's banner advertisement. When the banner advertisement is clicked, the service will check whether or not the Internet user is registered with the service. Registered users will be credited with the benefits, as noted on the banner advertisement. Users will not be permitted to receive the rewards from the same banner repeatedly. If an Internet user clicks on a banner advertisement offering said rewards but is not a registered user, the user will be allowed to register and then will receive the benefits. The service will store user data including user name, account number, amount and nature of rewards received, and the path by which all past rewards were received.

In accordance with an aspect of the present invention, a method for providing rewards to a user who reviews an advertiser's web site in response to clicking a banner advertisement, includes the steps of providing banner advertisements for a first group of a plurality of advertisers on a plurality of websites of a second group; linking the banner advertisements to respective websites of the first group of advertisers so that clicking on a banner advertisement by a user will bring the user to a respective website of the first group of advertisers; and providing rewards to the user for each banner advertisement clicked on by the user.

Preferably, the user is brought to a central website responsible for providing the rewards, between the steps of linking and providing rewards.

The step of providing rewards includes the steps of determining at the central website if the user is a registered user; and providing the rewards to the user for each banner advertisement clicked on by the user only if the user is a registered user. However, it is determined if the user has previously clicked on the same banner advertisement; and the rewards are not awarded to the user if the user has previously clicked on the same banner advertisement. In such case, a message is provided to the user, if the user clicks on a banner advertisement that had previously clicked on by the user, which informs the user that no rewards will be awarded to the user.

To determine at the central website if the user is a registered user, the central website checks a computer that the user is presently using for a cookie corresponding to the central website and which designates the user as a registered user, and if such cookie is not found, requires the user to submit a user name and password which is checked against a list of user names and passwords at the central website.

The user is permitted to register at the central website if the user is not a registered user, or enter a user name and password if the user is not located at his own computer and thereafter, the rewards are provided to the user for each banner advertisement clicked on by the user. Also, a cookie is placed on a user's computer after the user has registered.

In addition, confirmation is provided to the user at a computer then being used by the user, that the rewards have been credited to an account of the user. The user is also permitted to access an account of rewards of the user via a computer of the user preferably by clicking a secondary area of the banner that is coded with a different link.

Preferably, the rewards include airline reward miles.

The above and other objects, features and advantages of the present invention will become readily apparent from the following detailed description thereof which is to be read in connection with the accompanying drawings.

### BRIEF DESCRIPTION OF THE DRAWINGS

FIG. 1 is a plan view of a banner advertisement that can be used with the present invention;

FIG. 2 is schematic diagram of the general configuration of the Internet;

FIG. 3 is a block diagram of the general construction of a user's computer;

FIG. 4 is a block diagram of the general construction of a server;

FIG. 5 is a flow chart of the steps of a preferred embodiment of the present system when a user clicks on a banner advertisement; and

FIG. 6 is a flow chart of the steps of a modified embodiment of the present system when a user clicks on a banner advertisement.

### DETAILED DESCRIPTION OF THE PREFERRED EMBODIMENT

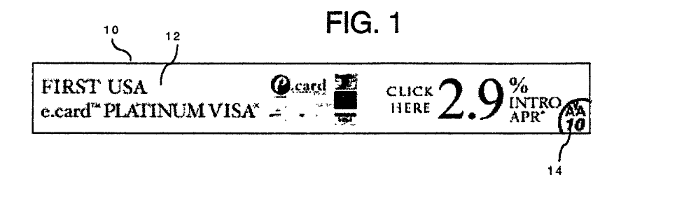

The present invention is directed to an improved system of advertising on websites by use of banner advertisements. A sample banner advertisement 10 that can appear on a website is shown in FIG. 1. As is conventional, banner advertisement 10 displays information 12 about a sponsor company, and also provides a link to the sponsor company by clicking anywhere on banner advertisement 10 with a computer mouse. Information 12 can be rearranged or adapted in various ways.

In accordance with the present invention, as will now be described, Internet users are presented with the opportunity to be rewarded with frequent flier miles in return for clicking on banner advertisement 10 so as to link to and view the advertiser's web site. Preferably, banner advertisement 10 will include a logo 14 in a corner portion thereof which will be designed so that the airline miles offer is posted secondary to the main portion of the banner advertisement, while still being distinctive and noticeable. This will provide an indication to the user that airline frequent flier miles can be accumulated for that airline by clicking on banner advertisement 10. As will be described hereinafter, the system is preferably set up such that a person clicking on banner advertisement 10 must be a registered user in order to be credited with the airline miles. In such case, the website which contains banner advertisement 10 will save each user's information so that the user will not have to register or enter his or her user information each time that a banner advertisement is clicked by the user.

Further, the system will provide its own website so that a user may access the user's account directly and check on the number of free miles the user has accumulated by clicking through participating banner advertisements. The system will also check the path through which a user has gained miles so that a user may not repeatedly click through the same advertisement and continually be credited with airline miles.

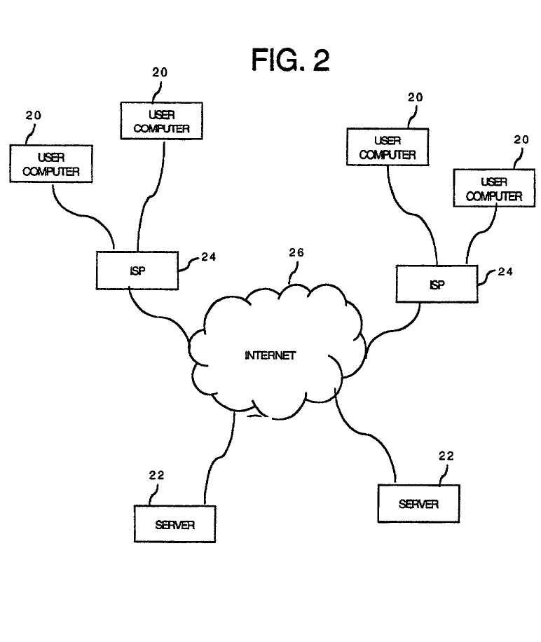

Referring now to FIG. 2, there is shown the general configuration of the Internet. Specifically, a plurality of servers 22 can be accessed by a plurality of users' computers 20 through various Internet service providers (ISP) 24 and the Internet 26. When a user clicks on a banner advertisement 10, the user is connected with the server 22 corresponding to the sponsor of the banner advertisement. As discussed above, there is also a website where a user may access the user's account directly and check on the number of free miles the user has accumulated. Thus, there is a server 22 corresponding to this website as well.

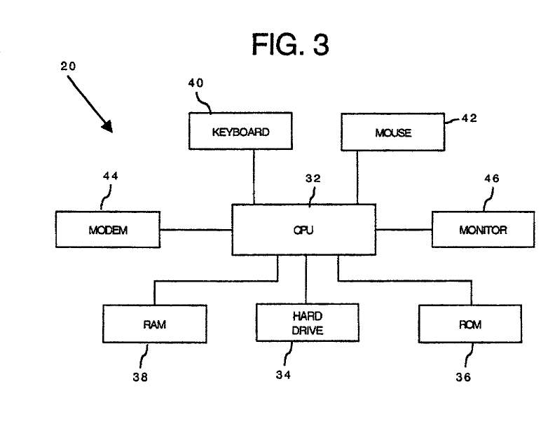

As shown in FIG. 3, and as is well known, each user's (remote) computer 20 includes a central processing unit (CPU) 32, a storage memory in the form of a hard drive 34 and read only memory (ROM) 36, for storing an operating system and programs, working memory 38 in the form of a random access memory (RAM), a keyboard 40 for inputting information and commands, a mouse 42 for inputting information and commands, a modem 44 for connecting CPU 32 to an ISP 24 and the Internet 26, and a monitor or display 46. As is well known, computer 30 must include a browser such as that sold by Netscape Communications Corp. under the trademark NETSCAPE COMMUNICATOR or that sold by Microsoft Corp. under the trademark INTERNET EXPLORER.

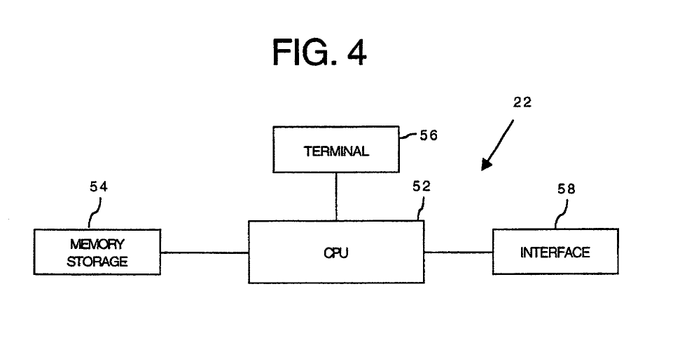

In like manner, as shown in FIG. 4, each server 22 will include a central processing unit (CPU) 52, memory storage 54 for an operating system, programs and data, at least one terminal 56 for inputting and viewing information and commands, and an interface 58 for connecting CPU 52 to the Internet 26. Server 22 stores web pages that are displayed, which include banner advertisements 10.

One skilled in the art will appreciate that these various sections of the user's computer 20 and server 22 can be omitted, rearranged or adapted in various ways. In general, the Internet user is required to have a browser, and server 22 is required to have web pages to be displayed along with links to advertiser's websites corresponding to the banner advertisements.

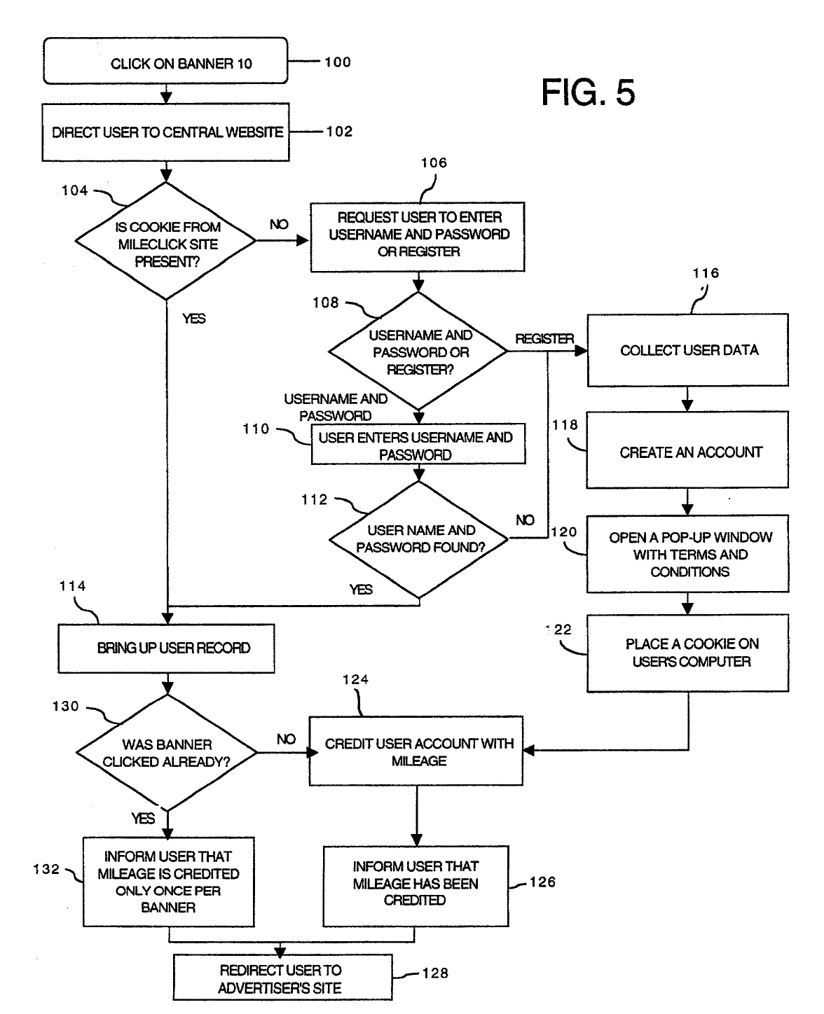

Referring now to FIG. 5, there is shown a flow chart of the steps of a preferred embodiment of the present system when a user clicks on a banner advertisement 10 at a website. Specifically, in step 100, an Internet user first clicks on a banner advertisement 10 of a participating advertiser. In step 102, the user is then directed to the central tracking website which keeps track of registered users and which keeps track of the banner advertisements that have been clicked by each registered user. In step 104, the server at the central tracking website checks the user's computer 20 (and specifically the computer's hard drive) for a cookie containing the Internet user's user information, and particularly, to determine whether a cookie is present from the central tracking website. This determines whether the user is a registered user.

The server at the central tracking website must first confirm that the stored information is correct. If the server fails to find the cookie on the user's computer, the server will then request the user to sign in, or, to register. For example, the user may be accessing the central website from a different computer. The user is therefore requested to enter the correct user name and password in step 106, or if the user is new to the system, the user is requested to register.

In the next step 108, the central website makes a determination if the user is registering or the user will enter a user name and password. If the user enters a user name and password in the next step 110, the central website then determines in step 112 whether the user name and password are found in the database at the central website. If yes, the process continues to step 114 where the user record at the central website is retrieved. This step might be invisible to the user. In like manner, if a cookie of the central website is found in step 104, the process also continues to step 114 where the user record at the central website is retrieved.

If no at step 112, that is, if the user name and password are not found in the database of the central website, it is determined that the user is not a registered user and the process continues to the first registration step 116 of collecting user data. In like manner, in step 108, if the user elects to register, the process continues to step 116.

After the user enters the user data in step 116, an account is created at the central website in step 118, and a pop-up window is provided with the terms and conditions for the user to view in step 120. A further step (not shown) can also be provided which requests that the user agree with the terms and conditions. At this time, in step 122, a cookie is placed on the user's computer 20 by the server at the central website, so that it can be accessed the next time the user accesses a banner advertisement 10 with the logo of the airlines thereon.

Then, the process continues to step 124 where the user is credited with the miles, that is, the acquisition of the new miles is recorded to the user's account. In addition, in step 124, the banner advertisement 10 through which the user received the miles is recorded. The user is then informed in step 126 that the mileage has been credited to the user's account, and in the next step 128, the central website redirects the user to the advertiser's site corresponding to the advertisement banner 10 that was clicked by the user.

Returning to step 114, if a cookie is found in step 104 or if the user enters the correct user name and password in step 112, the user's record is retrieved in step 114. It is then determined in step 130 if the user had previously clicked on this banner advertisement 10. If no, the process continues through steps 124, 126 and 128 as described above. However, a user cannot be credited for a previously accessed banner advertisement. Therefore, if banner advertisement 10 was previously clicked by the user, a window will appear on the user's computer in step 132 that informs the user that mileage is credited only once per banner advertisement, and the process then continues to step 128 where the user is redirected to the advertiser's website.

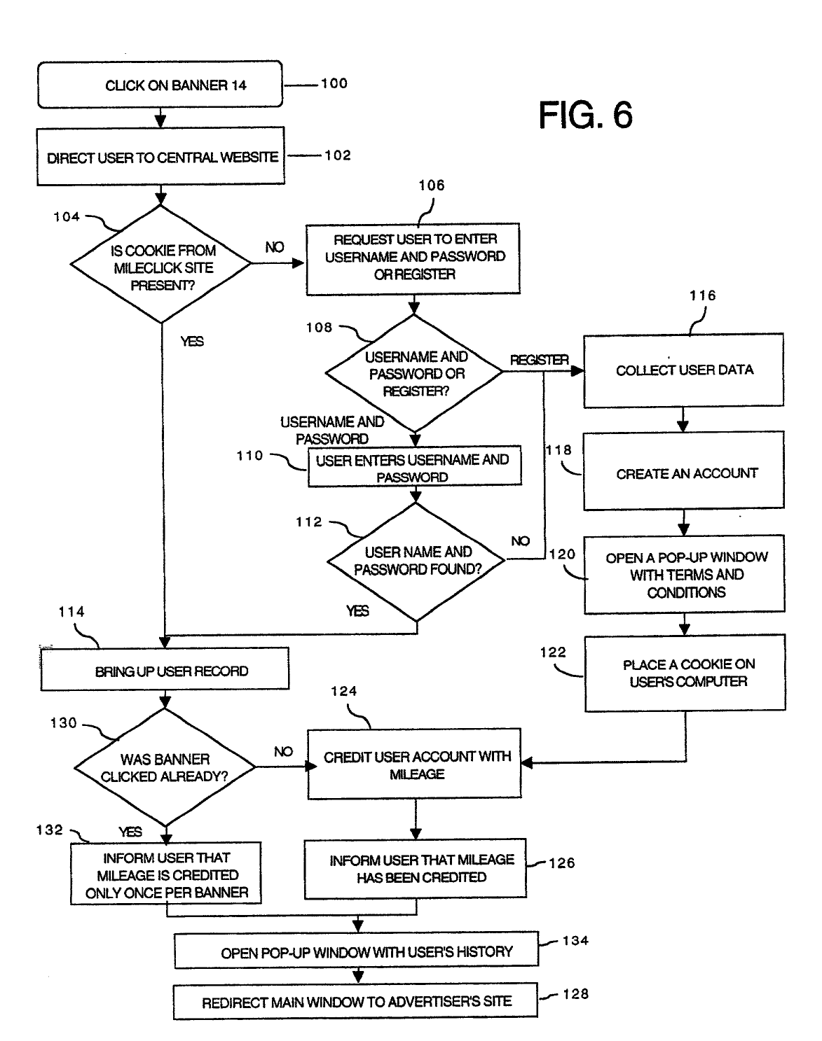

Alternatively, as shown in FIG. 6, a further step 134 can be inserted between steps 126 and 132 and step 128 in which a pop-up window opens with the user's history, thereby informing the user of the websites that have been visited and/or the total mileage accumulated by the user, prior to transferring the user to the advertiser's website. This pop-up window can open in a corner for viewing and/or be enlarged by the user, and can open for a predetermined period of time, for example, five seconds, giving the user time to click on the window and keep it open for a more detailed viewing.

It will therefore be appreciated that the present invention provides an Internet service that offers added value to Internet users, Internet advertisers, and a third party, in this case, major airlines. The service will add benefits to a popular form of Internet advertising, namely, the banner advertisement. The banner advertisement will provide a specified number of frequent flier miles to the Internet user in return for clicking the banner advertisement to the advertiser's web site. In effect, the advertiser whose banner advertisement offers the free miles will be paying the airline for the miles. By placing the offer for free miles on the advertiser's banner, an advertiser has increased the likelihood that an Internet user will visit its site. The Internet user gains the benefit of the rewarded benefit, while the airline gains free promotional space.

Thus, unlike conventional offers on the Internet, the present invention provides the benefits with respect to numerous websites. Therefore, the user need not go to a specific website to achieve the benefits. For example, if the user is viewing any website and sees a banner advertisement with the airlines logo thereon, the user need only click on the banner advertisement to be credited with the frequent flier miles, without having to visit a predetermined or fixed website.

It will be appreciated that various modifications can be made to the invention. For example, although the invention has been discussed in relation to airline reward miles, other types of rewards can be provided in place thereof. The banner can have one link that takes the user to a central website where a confirmation that the points were credited takes place and the user is automatically redirected to the advertiser's site. The banner can have one link that takes the user to the central website. There can be a button to click that would take the user to the advertiser's website after the interaction with the central website was completed. The banner can take the user to the central website where the confirmation can be viewed and automatically take the user to the advertiser's website. The banner can have one or more different links that provide different functions (e.g. if you click on the area coded #14 (the milage offer) then it could have a link directly to the central website and have the user stay there. Clicking the other area #10 could have a link that goes to the central website and then automatically takes the user to the advertiser's site. The process of the user being redirected to the central website can be either apparent or transparent to the user. The banners that are clicked on by the user are stored on the central website in a history file for the user to refer to in the future and review at a time when the user might be more inclined to review the advertiser's sites. There can be additional promotions linked to these stored banner advertisements such as additional points/miles to entice a user to review these advertised sites at a later time. Software can be developed that resides on the user's computer that links to the central website and automatically strips out advertisements from websites and replaces them with advertisements that are linked to the incentive program (i.e. ads with milage/points).

Having described specific preferred embodiments of the invention with reference to the accompanying drawings, it will be appreciated that the present invention is not limited to those precise embodiments and that various changes and modifications can be effected therein by one of ordinary skill in the art without departing from the scope or spirit of the invention defined by the appended claims.

What is claimed is:

1. A method for providing rewards to a user who reviews an advertiser's web site in response to clicking a banner advertisement, comprising the steps of:
providing banner advertisements for a first group of a plurality of advertisers on a plurality of websites of a second group;
linking said banner advertisements to respective websites of said first group of advertisers so that clicking on a banner advertisement by a user will bring the user to a respective website of said first group of advertisers; and
providing rewards to the user for each banner advertisement clicked on by the user.

2. The method according to claim 1, further comprising the step of bringing the user to a central website responsible for providing the rewards, between the steps of linking and providing rewards.

3. The method according to claim 2, wherein said step of providing rewards includes the steps of:
determining at the central website if the user is a registered user; and
providing said rewards to the user for each banner advertisement clicked on by the user only if the user is a registered user.

4. The method according to claim 3, wherein said step of providing said rewards to the user for each banner advertisement clicked on by the user only if the user is a registered user includes the further steps of:
determining if the user has previously clicked on the same banner advertisement; and
preventing an award of said rewards to the user if the user has previously clicked on the same banner advertisement.

5. The method according to claim 4, further including the step of providing a message to the user, if the user clicks on a banner advertisement that had previously clicked on by the user, which informs the user that no rewards will be awarded to the user.

6. The method according to claim 3, wherein said step of determining at the central website if the user is a registered user, includes at least one of the following steps:
checking a hard drive of a computer that the user is presently using for a cookie corresponding to the central website and which designates the user as a registered user; and
checking at least one of a password and user name of the user against a list of passwords and user names at the central website.

7. The method according to claim 3, wherein said step of providing rewards includes the steps of:
permitting the user at the central website to register if the user is not a registered user; and
thereafter providing said rewards to the user for each banner advertisement clicked on by the user.

8. The method according to claim 7, further comprising the step of placing a cookie in a user's computer hard drive after the user has registered.

9. The method according to claim 1, wherein said step of providing rewards includes the steps of:
determining if the user is a registered user; and
providing said rewards to the user for each banner advertisement clicked on by the user only if the user is a registered user.

10. The method according to claim 1, further comprising the step of providing confirmation to the user at a computer then being used by the user, that the rewards have been credited to an account of the user.

11. The method according to claim 1, further comprising the step of permitting a user to access an account of rewards of the user via a computer of the user.

12. The method according to claim 1, wherein the rewards comprise airline reward miles or incentive bonus points.

13. A method for providing rewards to a user who reviews an advertiser's web site in response to clicking a banner advertisement, comprising the steps of:
providing banner advertisements for a first group of a plurality of advertisers on a plurality of websites of a second group;
linking the banner advertisements to respective websites of the first group of advertisers;
bringing the user to a central website responsible for providing the rewards when the user clicks on a banner advertisement;
determining at the central website if the user is a registered user;
permitting the user to register at the central website if the user is not a registered user;
providing the rewards to each registered user for each new banner advertisement clicked on by the user; and
bringing the user to the respective website of the first group of advertisers.

14. The method according to claim 13, further including the step of providing a message to the user, if the user clicks on a banner advertisement that had previously clicked on by the user, which informs the user that no rewards will be awarded to the user.

15. The method according to claim 13, wherein said step of determining at the central website if the user is a registered user, includes at least one of the following steps:
checking a memory of a computer that the user is presently using for a cookie corresponding to the central website and which designates the user as a registered user; and
checking at least one of a password and user name of the user against a list of passwords and user names at the central website.
